(19) United States
(12) Patent Application Publication
(10) Pub. No.: US 2026/0276403 A1
(43) Pub. Date: Sep. 17, 2026

(54) Method and Device for Merging Digital Maps

(71) Applicant: Bayerische Motoren Werke Aktiengesellschaft, Muenchen (DE)

(72) Inventor: Daniel KOTZOR, Seefeld (DE)

(21) Appl. No.: 19/567,464

(22) Filed: Mar. 16, 2026

(30) Foreign Application Priority Data
Mar. 17, 2025 (DE) 10 2025 110 048.9

(51) Int. Cl. G01C 21/00; G01C 21/32

(52) U.S. Cl. CPC G01C 21/3807; G01C 21/32; G01C 21/387

(57) ABSTRACT

A method for merging map information from a first digital map and a second digital map is described. The method includes determining, for a subregion of the first and second digital map, a set of pairwise mappings between a first object from the first digital map and a second object from the second digital map in each case. The method includes determining a set of displacements that bring the set of mapped first and second objects into alignment with one another. The method includes determining a deformation function for deforming a partial grid for the subregion of the first and the second digital map depending on the set of displacements. The method includes using the deformation function to transfer map information from the subregion of the second digital map into the subregion of the first digital map.

### CROSS REFERENCE TO RELATED APPLICATION

This application claims priority under 35 U.S.C. § 119 from German Patent Application No. 10 2025 110 048.9, filed Mar. 17, 2025, the entire disclosure of which is herein expressly incorporated by reference.

### BACKGROUND AND SUMMARY

The invention relates to a method and a corresponding device, which are aimed at merging information from multiple digital maps, in particular to allow a convenient and safe automated operation of a vehicle.

A vehicle may have one or more driving functions, which are each designed to automatically guide the vehicle longitudinally and/or laterally. The operation of the one or more driving functions can be effected on the basis of a digital map for the road network being driven by the vehicle. Furthermore, sensor data from one or more environmental sensors, such as a camera and/or a radar sensor, of the vehicle are typically taken into account in the operation of the one or more driving functions.

The digital map used to operate a driving function may have inaccuracies that may result in corresponding inaccuracies in the automated longitudinal and/or lateral guidance of the vehicle. For example, a map inaccuracy with respect to the course of the lane the vehicle is driving on can lead to the vehicle not always being centrally located within the lane.

This document addresses the technical problem of increasing the accuracy of a digital map, in particular in order to achieve a convenient and accurate, automated longitudinal and/or lateral guidance of a vehicle.

At least this object is achieved by the features of the one or more embodiments disclosed herein, which illustrate the principles of the invention. It will be understood that the described features are not limited to combination in the specific embodiments disclosed, but rather may combined in any combination consistent with the principles disclosed herein without departing from the scope of the invention.

According to a first aspect, a method for merging map information from a first digital map and a second digital map is described. The digital maps can correspond to a total grid with a plurality of grid points. The total grid can be divided into a plurality of partial grids for a corresponding plurality of subregions of the digital maps. Different partial grids or different subregions may sometimes overlap. The individual grid points could be associated with a point or a coordinate of the respective digital map. Thus, deforming the grid for a map can result in a corresponding deformation of the map. In particular, a displacement of the individual grid points can lead to a corresponding displacement of the associated points or coordinates of the respective map.

The method comprises determining, for a subregion of the first and second digital map, a set of pairwise mappings between a first object from the first digital map and a second object from the second digital map in each case. A set of first objects in the subregion of the first map can be identified, for which a corresponding second object exists in the subregion of the second map. Examples of objects are: carriageway segments, landmarks, traffic signs, etc. The mapping can be carried out using a mapping algorithm.

The partial grid for the subregion may in some cases have a core region which is surrounded by an edge region of the partial grid. In a preferred example, the determined set of mappings in each case comprises only first and/or second objects which are located in the core region of the partial grid, and preferably no first and/or second objects which are located in the edge region of the partial grid. The core region can contain 50% or fewer of the grid points of the entire partial grid.

Furthermore, the method comprises determining a set of displacements (in particular displacement vectors) which bring the set of mapped first and second objects into alignment with one another. For each individual pairwise mapping, a displacement vector can be determined that moves the second object to the point or to the coordinate of the first object.

The method further comprises determining a deformation function for deforming the partial grid for the subregion of the first and the second digital map depending on the set of displacements. The deformation function can be determined by optimizing an optimization problem. The optimization problem can comprise at least one term which depends on the (possibly mean and/or squared) distance between the set of second objects in the subregion of the second digital map that is deformed by means of the deformation function and the mapped set of first objects in the undeformed subregion of the first digital map.

The deformation function is preferably a space morphing function. The partial grid typically comprises a matrix of grid points. The deformation function can comprise a matrix of spatial distortion vectors for the corresponding matrix of grid points. In this case, under the application of the deformation function the individual grid points can be displaced in each case according to the spatial distortion vector associated with the respective grid point.

The deformation function for the individual grid points of the matrix of grid points can comprise a kernel function, which specifies how a displacement of the respective grid point by the spatial distortion vector of the respective grid point affects one or more grid points in the environment of the respective grid point.

The deformation function can specify a displaced grid point fₛₘ(x₁) for an (arbitrary) grid point x₁ of the matrix. For example, the displaced grid point can be determined as

$${f}_{s m} ( {x}_{1} ) = {x}_{1} + {\sum }_{i = 1}^{n} k ( {x}_{i} , {x}_{1} ) \cdot {v}_{i}$$

where vᵢ is the spatial distortion vector for the grid point xᵢ of the partial grid; and where k(xᵢ,x₁) is a kernel function.

The kernel function is preferably formed such that the value k(x₁,x₁) decreases with increasing distance between the grid point x₁ and the grid point xᵢ. An example of a kernel function is

$$k ( {x}_{i} , {x}_{1} ) = {e}^{- 0.5 \cdot \frac{{( {x}_{i} - {x}_{1} )}^{2}}{σ}} or k ( {x}_{i} , {x}_{1} ) = {e}^{- 0.5 \cdot \frac{‖ {x}_{i} - {x}_{1} ‖}{σ}}$$

with an influence parameter σ that specifies the extent of the displacement of a particular grid point xᵢ to the grid point x₁.

In a corresponding manner, a deformation function can be determined for different partial grids of the total grid, in order to enable a fusion of the map information from the entire first and second digital map.

The method may comprise, for a sequence of partial grids for a corresponding sequence of subregions of the first and the second digital map respectively,
determining, for the respective subregion of the first and second digital map, a set of pairwise mappings between a first object from the first digital map and a second object from the second digital map in each case;
determining a set of displacements which cause the set of mapped first and second objects of the respective subregion to be aligned with one another; and
determining a deformation function for deforming the respective partial grid for the respective subregion of the first and second digital map depending on the set of displacements determined in each case, wherein directly consecutive partial grids of the sequence of partial grids can partially overlap.

In addition, the deformation function determined for the preceding partial grid can be taken into account when determining the deformation function of the directly following partial grid. Thus, a particularly efficient and precise deformation of the first and/or the second digital map can be effected in order to merge the map information from both maps.

The method further comprises transferring, by means of the deformation function for the respective subregion, map information from the respective subregion of the second digital map to the subregion of the first digital map. In this case the map information can comprise an object which appears in the subregion of the second digital map but not in the subregion of the first digital map. This allows the information content of the first digital map to be increased efficiently and accurately.

The method may also comprise determining a reliability indicator for the reliability of the determined deformation function for the respective subregion. The transfer of map information from the respective subregion of the second digital map into the respective subregion of the first digital map can then be effected in a particularly robust manner in accordance with the reliability indicator.

Another aspect describes a software (SW) program. The SW program can be configured to be executed on a processor and to thereby carry out the method described in this document.

Another aspect describes a storage medium. The storage medium may comprise an SW program that is configured to be executed on a processor and thereby to carry out the method described in this document.

At least one aspect describes a device for merging map information from a first digital map and a second digital map. The device is configured to determine, for a subregion of the first and second digital map, a set of pairwise mappings between a first object from the first digital map and a second object from the second digital map in each case. Furthermore, the device is configured to determine a set of displacements which bring the set of mapped first and second objects into alignment with one another. The device is further configured to determine, depending on the set of displacements, a deformation function for deforming a partial grid for the subregion of the first and the second digital map, and using the deformation function, to transfer map information from the subregion of the second digital map to the subregion of the first digital map.

It should be noted that the aspects described in connection with the method, in particular the claims described in connection with the method, can also be applied as corresponding features to the device.

Another aspect describes a (road) motor vehicle (in particular a passenger vehicle or a commercial vehicle or a bus or a motorcycle) that comprises the apparatus described in this document.

It should be noted that the methods, devices and systems described in this document may be used both on their own and in combination with other methods, devices and systems described in this document. Furthermore, any aspects of the methods, devices and systems described in this document may be combined with one another in a wide variety of ways. The features of the claims may in particular be combined with one another in a wide variety of ways. Furthermore, features in parentheses should be understood as optional features.

The invention is described in more detail below with reference to exemplary embodiments.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows exemplary components of a vehicle;

FIG. 2 shows exemplary digital maps for a specific subregion of the Earth's surface;

FIG. 3a shows an exemplary total grid for a digital map;

FIG. 3b shows an exemplary deformed partial grid for deforming a map section; and

FIG. 4 shows a flowchart of an exemplary method for determining a merged digital map.

### DETAILED DESCRIPTION OF THE DRAWINGS

As explained above, this document is concerned with increasing the convenience and/or safety of the operation of a vehicle, in particular with regard to the automated longitudinal and/or lateral guidance of the vehicle. In this context, FIG. 1a shows an exemplary vehicle 100 that comprises one or more environment sensors 102. Examples of environment sensors 102 are a camera, a radar sensor, a lidar sensor, an ultrasonic sensor, etc. The one or more environment sensors 102 are configured to acquire environmental data (i.e. sensor data) in relation to the environment of the vehicle 100.

The vehicle 100 further comprises a position sensor 104, which is configured to determine position data (i.e. sensor data) with respect to the position of the vehicle 100 in a world coordinate system and/or within a digital map by means of a global satellite-based navigation system (GNSS), e.g. by means of GPS.

Furthermore, the vehicle 100 comprises one or more vehicle sensors 103, which are configured to determine sensor data with respect to one or more measurement variables, for example, the driving speed (longitudinally, laterally and/or vertically), the steering angle and/or the rotation rate (about the longitudinal axis, about the transverse axis and/or about the vertical axis), which allow an odometry-based determination of the relative movement of the vehicle 100 over time (in particular between two consecutive points in time).

In addition, the vehicle 100 may comprise an acceleration sensor 105 which is configured to determine measured values with respect to a (three-dimensional) acceleration vector of the vehicle 100. For example, the acceleration sensor 105 can comprise an inertial measurement unit (IMU) or be part of an IMU.

Thus, sensor data can be acquired from a vehicle 100 while driving on a road, wherein the sensor data comprises, for example,
position measurements of a GNSS sensor 104;
odometry measurements related to the movement of the vehicle 100; and/or
camera images to detect landmarks around the vehicle 100.

The sensor data can be acquired for a sequence of times when the vehicle is driving along the road. The sensor data can be used, e.g. by the (control) device 101 of the vehicle 100, to localize the vehicle 100 on the road. For this purpose, a SLAM (Simultaneous Localization and Mapping) algorithm can be used.

The position measurements of the GNSS sensor 104 can be used to determine the position of the vehicle 100 within a digital map. The digital map can be used to extract information that can be used for automated longitudinal and/or lateral guidance, such as the course of the road driven on by the vehicle 100, and/or the position of one or more landmarks, and/or the position and type of traffic signs. A digital map may exhibit inaccuracies and/or information may be missing from the digital map (such as a traffic sign that is not indicated).

Multiple different digital maps may be available for a specific area of the Earth's surface. For example, a map provider might supply a digital map which was created, for example, on the basis of the sensor data from measurement vehicles. Such a digital map can have relatively high accuracy for major traffic routes. On the other hand, such a digital map may not be available for secondary traffic routes, and/or the digital map may be out of date such that stored information is incorrect and/or some information is unavailable.

For the particular land area, a further digital map may be available, which has been determined on the basis of the environmental data of a plurality of vehicles 100 and which contains relatively up-to-date information as a result. On the other hand, such a digital map will often have a relatively low accuracy.

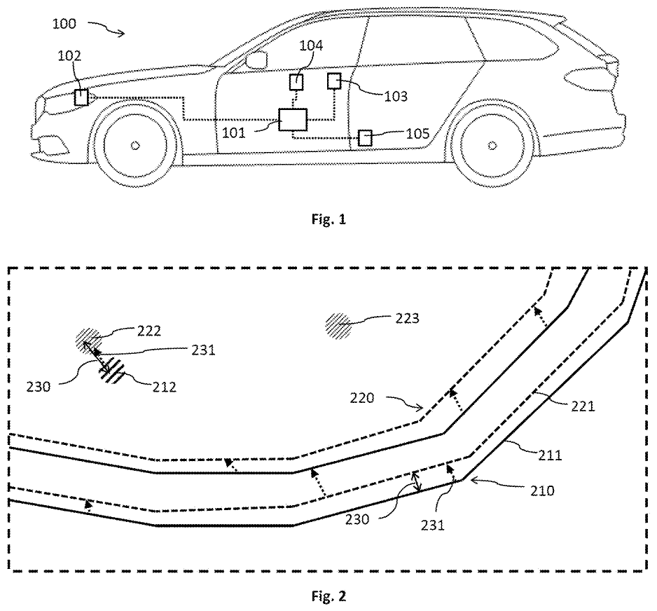

FIG. 2 shows a superimposed illustration of a first digital map 210 and a second digital map 220 for a specific land area, wherein the first digital map 210 contains first objects 211, 212 and the second digital map 220 contains second objects 221, 222, 223. Examples of objects are: carriageway segments and/or segments of carriageway markings, landmarks, traffic signs, etc.

As is clear from FIG. 2, the different digital maps 210, 220 are typically not congruent. In particular, the same and/or corresponding objects 211, 221 or 212, 222 in the different digital maps 210, 220 can be recorded at different positions, so that a direct merging of the information from both digital maps 210, 220 is typically not straightforward. In order to nevertheless allow a precise merging of information from a plurality of digital maps 210, 220, a deformation of one of the two maps 210, 220 or of both maps 210, 220 can be effected, the purpose of the deformation being to bring the objects 211, 221 and 212, 222 respectively, which are recorded in both the first digital map 210 and the second digital map 220, into alignment with each other as closely as possible. As a result, the information relating to an object 223, which is recorded in only one of the two maps 210, 220, can be incorporated into the merged map in order to provide a merged map that has an increased information content.

In a first step, a mapping 230 between a set of first objects 211, 212 from the first digital map 210 and a set of second objects 221, 222 from the second digital map 220 can be determined. The mapping 230 can specify pairs of corresponding objects 211, 221 or 212, 222 from both digital maps 210, 220. The mapping 230 can be determined, for example, by means of a Nearest Neighbor algorithm, by means of a Hungarian Matching algorithm and/or by means of a Template Matching algorithm.

For the individual mappings 230, a displacement vector 231 d can be determined in each case, by means of which the two objects 211, 212 of the respective mapping 230 can be brought into alignment with each other. Thus, a corresponding set of displacement vectors 231 can be determined for the set of mappings 230.

The first digital map 210 and/or the second digital map 220 can contain, in addition to the respective set of assigned objects 211, 212 or 221, 222 respectively, one or more objects 223 for which no corresponding object can be found in the other digital map 210, 220. The measures described in this document allow these one or more objects 223 to be accurately incorporated into a merged map.

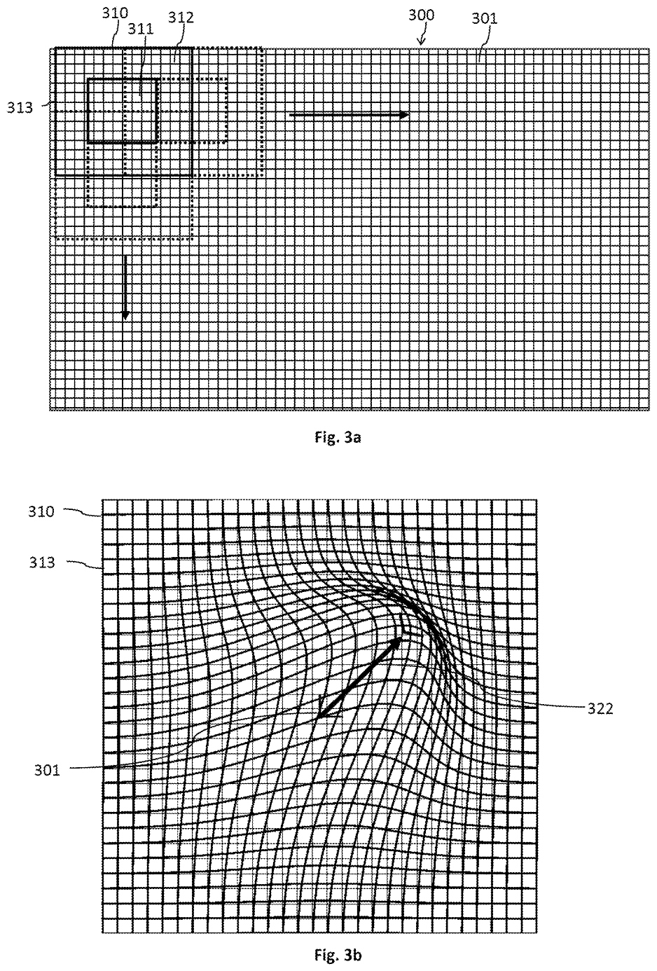

After the determination of a mapping 230 of object sets from both digital maps 210, 220, a deformation of the first digital map 210 and/or the second digital map 220 can be effected, the purpose of the deformation being to reduce, in particular to minimize, a distance measure for the distance between the sets of mapped objects 211, 212 or 221, 222. The deformation of one or both digital maps 210, 220 can be effected efficiently and accurately by means of one or more morphing functions, as illustrated in FIGS. 3a and 3b.

FIG. 3a shows an exemplary total grid 300 for a digital map 210, 220, wherein the total grid 300 contains a plurality of grid points 301. The grid points 301 can have a certain distance from each other, e.g. a distance between 1 and 5 meters. The total grid 300 can contain a matrix of grid points 301.

Within the total grid 300, a partial grid 310 can be considered, wherein the partial grid 310 has a core region 311 and an edge region 312. The core region 311 is completely surrounded by the edge region 312. The partial grid 310 may contain, for example, N×M grid points 301, and the core region 311 of the partial grid 310 may contain Q×R grid points 301, where Q<N and R<M is. In a preferred example, Q=N/3 and R=M/3. The core region 311 may be arranged in the center of the partial grid 310, and the edge region 312 may have the shape of a rectangular frame around the core region 311. The edge region 312 can have a width of (N−Q)/2 or (M−R/2). In the preferred example, the width of the edge region 312 is N/3 or M/3.

For each individual partial grid 310, a deformation can be effected to reduce the value of the distance measure of the set of mapped objects 211, 221 located in the respective partial grid 310, in particular in the core region 311 of the respective partial grid 310. The deformation of a partial grid 310 can be effected efficiently and accurately by means of a morphing function. As already explained, a partial grid 310 can correspond to a matrix of N×M points 301, where N, M have values between 5 and 20, for example. The individual grid points 301 can each be associated with a morphing function, wherein the morphing function effects a displacement of the respective grid point 301 and of grid points in the environment of the respective grid point 301. In this case, the individual morphing functions for the individual grid points 301 are formed in such a way that no displacement occurs at the edge 313 of the partial grid 310. This condition can be used to ensure that the deformed map section of a digital map 210, 220 corresponding to the deformed partial grid 310 also exhibits no deformation at the edge of the deformed map section.

The morphing function for a particular grid point 301 can be defined by a (spatial) distortion vector 322. This distortion vector 322 can correspond to a rotation and/or a translation (an example of a translation being illustrated in FIG. 3b). The distortion vector 322 for the specific grid point 301 can be scaled for the grid points in the neighborhood of the specific grid point 301 with a specific scaling factor K, wherein the scaling factor K typically decreases with increasing distance from the specific grid point 301.

The displacement of a grid point 301 (based on a distortion vector 322) thus leads to a displacement of grid points in the neighborhood of the respective grid point 301 that depends on the displacement of the grid point 301. Since each grid point 301 is also located in the neighborhood of the other grid points 301 of the partial grid 310, the displaced position of a grid point 301 results from the superpositions of the displacements of all grid points 301 of the partial grid 310.

The individual grid points 301 of the partial grid 310 can be combined in a matrix

$$x = {[ \begin{matrix}{x}_{1} & … & {x}_{n}\end{matrix} ]}^{T}$$

where n is the number of grid points 301 of the partial grid 310, and where the xᵢ, with i=1, . . . , n represent the individual grid points 301 (e.g. in each case by coordinates of a two-dimensional Cartesian coordinate system). The individual distortion vectors 322 for the individual grid points 301 can be similarly combined in a matrix,

$$v = {[ \begin{matrix}{v}_{1} & … & {v}_{n}\end{matrix} ]}^{T}$$

The displaced grid points fₛₘ(x) 301 of the partial grid 310 can then (if morphing functions that perform a translation of the individual grid points 301 are used) be described by the following linear matrix equation,

$$\hat{x} = {f}_{s m} ( x ) = x + K \cdot v$$

where K is a matrix with the scaling factors of the individual morphing functions and the individual grid points 301, with

$$K = [ \begin{matrix}K & 0 \\ 0 & K\end{matrix} ]$$

$$and$$

$$K = [ \begin{matrix}k ( {\hat{x}}_{1} , {x}_{1} ) & … & k ( {\hat{x}}_{n} , {x}_{1} ) \\ ⋮ & ⋱ & ⋮ \\ k ( {\hat{x}}_{1} , {x}_{m} ) & … & k ( {\hat{x}}_{n} , {x}_{m} )\end{matrix} ]$$

where k(\hat{x}₁,xⱼ) is the scaling factor of the morphing function for the grid point \hat{x}ᵢ, with i=1, . . . , n, and where xⱼ is a grid point in the neighborhood of the grid point \hat{x}ᵢ (with i=1, . . . , m). Here n is the number of grid points 301 that are displaced in the partial grid 100. m The number of adjacent grid points is 301 (where typically m<n).

The morphing function, in particular the so-called kernel function, for determining the scaling factors k(\hat{x}ᵢ,xⱼ) can be positive and definite. An example of a kernel function is

$$k ( {\hat{x}}_{i} - x ) = {e}^{- 0.5 \cdot \frac{{( {\hat{x}}_{i} - x )}^{2}}{σ}} or k ( {\hat{x}}_{i} - x ) = {e}^{- 0.5 \frac{‖ {\hat{x}}_{i} - x ‖}{σ}}$$

wherein
σ is an influence parameter indicating the extent of the displacement of a specific grid point \hat{x}ᵢ 301 onto the grid points x 301 in the neighborhood of the specific grid point \hat{x}ᵢ 301; this influence parameter can be optionally defined in advance;
\hat{x}ᵢ is the grid point is 301 that is displaced; and
x is a grid point 301 in the neighborhood of the grid point \hat{x}ᵢ.

Thus, for the individual grid points \hat{x}ᵢ 301 of the partial grid 310, a spatial distortion (in particular a displacement) vᵢ can be determined in each case. From the spatial distortions (in particular from the displacements) vᵢ of all grid points 301, the deformed partial grid 310 is then obtained, from which a correspondingly deformed map section of a digital map 210, 220 can be determined.

As already explained, different maps 210, 220 are typically geometrically not congruent. Moreover, the differences in the maps 210, 220 are neither known nor quantified a priori. It is therefore typically not known whether two maps 210, 220 differ from each other by a large or small amount at a given point. Therefore, only a single map is preferably used to localize a vehicle 100. For safety reasons, it is usually not possible to change maps while the vehicle 100 is driving. This means that only the data of the map 210 used for localization can be accessed. The information from another map 220 cannot then be used.

The measures described in this document allow the geometric differences of different digital maps 210, 220 to be measured. Furthermore, the different digital maps 210, 220 (depending on the degree of confidence) can be merged into a single map and/or the maps 210, 220 can be brought into geometrical alignment.

The merger of the maps 210, 220 can be effected using Space Morphing. This makes it possible to curve the space independently of a map 210, 220 and thus to modify the map 210, 220 geometrically and/or thus merge two maps 210, 220 into each other. Since the spatial distortion caused by space morphing is locally applied, a natural and smooth transition between modified and unmodified map sections is achieved.

The spatial distortions required to match the alignment of the two maps 210, 220 can be interpreted as a measure of confidence in the maps 210, 220. If both maps 210, 220 are congruent or can be made congruent with small spatial distortions, the degree of confidence in the resulting curved (merged) map is typically higher than if the space needs to be distorted relatively severely in order to merge the maps 210, 220 into each other.

In the context of the merger, the first map 210 can be used as a “master map”, which is not deformed. On the other hand, the second map 220 can be used as a “correction map”, which is deformed in order to transfer information from the second map 220 into the first map 210. In particular, further information not yet contained in the master map (e.g. object 223) can be distorted from the second map 220 and incorporated consistently into the master map. The topology of the master map remains unchanged. The parameters required for the correction (in particular the spatial distortions 322) can be determined in the Reproducing Kernel Hilbert Space (RKHS).

As already explained, in a first step, points 211, 212 with coordinates of the first digital map 210 (master map) can be associated to corresponding points 221, 222 from the second digital map 220. Typically, not all elements are present in both maps 210, 220, so only the elements (i.e. objects) that are found in both maps 210, 220 are associated. Objects that have a unique semantics (e.g. a traffic light with an identifier) can be associated using the semantics (e.g. using the identifier). Geometric objects without semantics can be associated with an association algorithm, e.g.

Nearest neighbor algorithm: this decomposes the maps 210, 220 into points with coordinates and identifies the best pairs.

Hungarian Matching: the maps are decomposed into points with coordinates and pairs are identified for “perfect matching”. For example, the total distance can be used as an error term.

Template matching: The maps 210, 220 can be transformed into pixel-based images, for example, by means of map rendering, and pairs of map sections from the two maps 210, 220 can be identified.

In a subsequent step, a geometrical fitting of the maps 210, 220 is carried out, e.g.
adapting the first map 210 to the geometry of the second map 220;
adapting the second map 220 to the geometry of the first map 210; or
adapting the geometries of both maps 210, 220.

The geometries are adjusted in the form of a geometry correction. Topologically and from the data format, the difference between the two maps 210, 220 is typically preserved. For example:
a branching point in the first map 210 remains a branching point even after the geometrical adjustment. It may be that this branching point does not exist in the second map 220, and even after the geometrical adjustment by space morphing, there will typically be no branching point in the second map 220.
the two maps 210, 220 are preferably fully preserved in their data format, regardless of whether, for example, a road is stored as a line-string or as a different geometric element. The deformation based on morphing is typically a function trained on the basis of the different maps 210, 220, which transforms coordinates in such a way that the maps 210, 220 match each other geometrically.

This procedure is advantageous for the following reasons:
a geometrical adjustment allows both maps 210, 220 to be used simultaneously;
the original maps 210, 220 can be preserved in their entirety;
the required computing time is relatively low and calculations are only performed locally (on relatively small map sections);
coordinates for which there no direct matching (i.e. a mapping 230) exists are also adjusted, since a soft spatial distortion is performed. For example, the object 223 from FIG. 2 is also displaced, so that this object 223 can be transferred in a precise manner into a merged map.

A preferred form of deformation based on morphing uses a so-called RKHS (Reproducing Kernel Hilbert Space) as a functional space for adjusting the geometry of the first and/or second map 210, 220. This space allows a seamless geometrical adjustment of geometries. The distortions of the space performed by the RKHS can be illustrated as described in this document.

Each point x_{g} 301 of a partial grid 310 is pulled onto a corresponding deformed partial grid 310 by means of a spatial distortion 322. This changes the positions of all points 301 around the coordinate x_{g}, but the points 301 at the edge 313 of the partial grid 310 are not transformed. For example, the following applies to the spatial distortion shown in FIG. 3b:

$${x}_{g} = [ \begin{matrix}0 \\ 0\end{matrix} ] :$$

single grid point \hat{x}ᵢ which is displaced;

$$v = [ \begin{matrix}3.8 \\ 3.8\end{matrix} ] :$$

Exemplary spatial distortion vector 322, which describes the displacement of the original partial grid 310 to the deformed partial grid 310;

$$k ( {x}_{g} - x ) = {e}^{- 0.5 \cdot \frac{{( {x}_{g} - x )}^{2}}{σ}} or k ( {x}_{g} - x ) = {e}^{- 0.5 \cdot \frac{‖ {x}_{g} - x ‖}{σ}} :$$

an exemplary kernel function that defines the RKHS, e.g. with an influence parameter σ=3.3 that describes the correlations of the spatial distortion.

Thus, for each point x 301 in the partial grid 310, the associated point \tilde{x} in the distorted space (i.e. in the deformed partial grid 310) is defined as follows

$$\tilde{x} = F ( x ) = x + k ( {x}_{g} - x ) \cdot v$$

The deformation function for deforming a partial grid 310 (based on space morphing) can thus be defined by a set of mesh points x_{g}, associated distortion vectors v and a kernel function k(x_{g}−x). With multiple grid points, the spatial displacement can be represented in matrix notation as follows

$$\tilde{x} = x + K ( {x}_{g} - x ) \cdot v$$

with K as the kernel matrix (with the core or kernel functions for the individual spatial distortions) and with the distortion vectors (combined in a matrix) v for each grid point.

After defining the kernel function, suitable grid points 301 and/or spatial displacements are found which match the displacement vectors 231 determined as part of the mapping 230 of objects 211, 212. This can take advantage of the fact that, if the grid points x_{g} considered are distributed in space uniformly and in a grid pattern (for example, at each intersection point of the partial grid 310), this grid can be used to represent any possible spatial distortion, so that even an infinitely dense grid does not provide a significant increase in accuracy. A suitable choice of grid spacing typically depends on the definition of the kernel function and can be chosen as 0.5σ, for example.

When using a defined kernel function k and a defined partial grid 310 with the grid points x_{g} 301 the spatial distortion is defined solely by the spatial distortion vectors v. The spatial distortion vectors v for a partial grid 310 can be determined by solving a linear system of equations.

$$K ( {x}_{g} - x ) \cdot v - d {=}^{!} 0$$

wherein d are the one or more displacement vectors 231 of the set of mapped objects 211, 212 that are arranged in the core region 311 of the partial grid 310.

An advantage of the definition of spatial distortions described in this document is the very local influence of the distortion vectors 322 on the respective environment. If a deformation function, in particular a spatial morphing function, has been determined (based on the set of spatial distortion vectors v) for a specific map section (e.g. for a specific partial grid 310), it is typically sufficient to update the deformation function (i.e. the set of spatial distortion vectors) for this map section when the map section is changed. The complete map information is not required for this. Displacements in the core region 311 of the section 310 only have an effect on the edge region 312 of the section 310 (i.e. of the partial grid 310).

It is therefore possible to determine the deformation functions for individual map sections (and corresponding partial grids 310) iteratively piece by piece. For this purpose, the partial grids 310 can be displaced progressively, as illustrated in FIG. 3a by the arrows. The calculations can also be carried out in parallel, which enables a particularly efficient determination of the deformation functions.

As shown in FIG. 3a, the partial grid 310 can be displaced in an overlapping manner to progressively cover the total grid 300. The individual partial grids 310 can be identified, for example, by an index t, wherein the index t increases with the displacement of the partial lattice 310 over the total grid 300. In a partial grid 310 t, in particular in the core region 311 of the partial grid 310 t, a set of mappings 230 may be present with a corresponding set of displacement vectors dₜ 231. Furthermore, for a portion of the grid points 301 of the partial grid 310 t, distortion vectors vₜ₋₁ from the previous determination step for the previous partial gridt−1 can be available. Based on this, a set of output distortion vectors sₜ can be determined to determine the set of distortion vectors vₜ for the partial grid 310 t. The set of distortion vectors vₜ for the partial grid 310 t can be determined by means of an optimization problem, with an example optimization problem defined by the following function

$${v}_{t} = {min}_{{\tilde{v}}_{t}} [ {( {d}_{t} - h ( {s}_{t} , {\tilde{v}}_{t} ) )}^{T} {\sum }_{{d}_{t}}^{- 1} ( {d}_{t} - h ( {s}_{t} , {\tilde{v}}_{t} ) ) + {\tilde{v}}_{t}^{T} {\sum }_{{v}_{k - 1}}^{- 1} {\tilde{v}}_{t} ]$$

where:
h(sₜ, \tilde{v}ₜ) is a prediction function (defined in advance) that enables, based on the existing initial distortion vectors sₜ and the distortion vectors \tilde{v}ₜ, the expected displacement vectors h(sₜ, \tilde{v}ₜ) to be calculated.

$${\sum }_{{d}_{t}}^{- 1}$$

is a (covariance-based) weighting matrix.

$${\sum }_{{v}_{k - 1}}^{- 1}$$

is a (covariance-based) weighting matrix.

The second term of the optimization problem is aimed at causing the smallest deformations of the partial grid possible. This term typically increases the stability of the optimization process.

Thus, distortion vectors 322 can be determined progressively for the individual grid points 301 of the total grid 300. Furthermore, a covariance value can be determined for the individual grid points 301, which indicates the quality and/or reliability of the distortion vector 322.

The individual distortion vectors 322 can be used to bring individual subregions of the two different maps 210, 220 into alignment with each other, and thereby to provide a merged digital map which contains information from both digital maps 210, 220.

During the operation of a vehicle 100, the automated longitudinal and/or lateral guidance can be performed, e.g. on the basis of the first digital map 210. If necessary, information 223 from the second digital map 220 can be incorporated into the first digital map 210. The distortion vectors 322, which were determined for a partial grid 310 which comprises the respective current position of the vehicle 100, can be used. Thus, information from a second digital map 220 can be incorporated into the first map 210 as if the two maps 210, 220 were a single merged digital map.

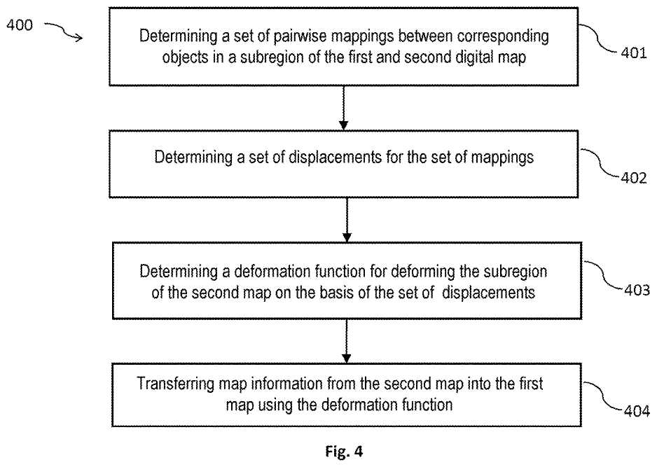

FIG. 4 shows a flowchart of a (possibly computer-implemented) method 400 for merging map information from a first digital map 210 and a second digital map 220. The method 400 can be carried out by a device 101. The method 400 comprises determining 401, for a subregion of the first and second digital map 210, 220, a set of pairwise mappings 230 between a first object 211 from the first digital map 210 and a second object 221 from the second digital map 220 in each case, and determining 402 a set of displacements 231 (in particular of displacement vectors) which bring the set of mapped first and second objects 211, 221 (pairwise in each case) into alignment with one another. The subregion can correspond to a specific subregion of the Earth's surface. A partial grid 310 with a matrix of grid points 301 can be defined for the subregion. The individual grid points 301 can each be associated with a point or a coordinate of the subregion. The displacement of a grid point can result in a corresponding displacement of the point or coordinate associated with it. Thus, a corresponding deformation of the subregion can be effected by the deformation of the partial grid 310.

Furthermore, the method 400 comprises determining 403 a deformation function for deforming a partial grid 310 for the subregion of the first and second digital map 210, 220 depending on the set of displacements 231. The deformation function can be defined by spatial distortion vectors 322 for each grid point 301. The spatial distortion vectors 322 can be determined by optimizing an optimization function, where the optimization function depends on the set of displacements 231.

The method 400 further comprises transferring 404, by means of the deformation function, map information from the subregion of the second digital map 220 to the subregion of the first digital map 210. This allows a particularly robust and precise merging of digital maps 210, 220 to be effected.

The present invention is not restricted to the exemplary embodiments that are shown. In particular, it should be noted that the description and the figures are intended to illustrate the principle of the proposed methods, devices and systems only by way of example.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for merging map information from a first digital map and a second digital map, comprising:
determining, for a subregion of the first and second digital map, a set of pairwise mappings between a first object from the first digital map and a second object from the second digital map;
determining a set of displacements which bring the set of mapped first and second objects into alignment with one another;
determining a deformation function for deforming a partial grid for the subregion of the first and second digital map depending on the set of displacements; and
transferring, using the deformation function, map information from the subregion of the second digital map into the subregion of the first digital map.

2. The method of claim 1,
wherein the partial grid comprises a matrix of grid points, and
wherein the deformation function comprises a matrix of spatial distortion vectors for the corresponding matrix of grid points.

3. The method of claim 2, wherein the deformation function for the individual grid points of the matrix of grid points comprises a kernel function that specifies how a displacement of the respective grid point by the spatial distortion vector of the respective grid point affects one or more grid points in the environment of the respective grid point.

4. The method of claim 2, wherein the deformation function for a grid point x₁ of the matrix of grid points specifies a displaced grid point fₛₘ(x₁), as
$${f}_{s m} ( {x}_{1} ) = {x}_{1} + {\sum }_{i = 1}^{n} k ( {x}_{i} , {x}_{1} ) \cdot {v}_{i}$$
where vᵢ is the spatial distortion vector for the grid point xᵢ of the partial grid, and where k(xᵢ,x₁) is a kernel function.

5. The method of claim 4, wherein the kernel function is formed such that the value k(xᵢ,x₁) decreases with increasing distance between the grid point x₁ and the grid point xᵢ.

6. The method of claim 4, wherein the kernel function is
$$k ( {x}_{i} - {x}_{1} ) = {e}^{- 0.5 \cdot \frac{{( {x}_{i} - {x}_{1} )}^{2}}{σ}} or k ( {x}_{i} , {x}_{1} ) = {e}^{- 0.5 \cdot \frac{‖ {x}_{i} - {x}_{1} ‖}{σ}}$$
with an influence parameter σ that specifies the extent of the displacement of a particular grid point xᵢ onto the grid point x₁.

7. The method of claim 1,
wherein the deformation function is determined by optimizing an optimization problem, and
wherein the optimization problem comprises at least one term that depends on the distance between the set of second objects in the subregion of the second digital map that is deformed by means of the deformation function and the mapped set of first objects in the undeformed subregion of the first digital map.

8. The method of claim 1, further comprising:
in each case for a sequence of partial grids for a corresponding sequence of subregions of the first and the second digital map:
determining, for the respective subregion of the first and second digital map, a set of pairwise mappings between a first object from the first digital map and a second object from the second digital map;
determining a set of displacements which cause the set of mapped first and second objects of the respective subregion to be aligned with one another; and
determining a deformation function for deforming the respective partial grid for the respective subregion of the first and second digital map depending on the set of displacements determined in each case.

9. The method of claim 8,
wherein directly consecutive partial grids of the sequence of partial grids partially overlap; and
wherein the deformation function determined for the preceding partial grid is taken into account when determining the deformation function of the directly following partial grid.

10. The method of claim 1, further comprising:
determining a reliability indicator for the reliability of the determined deformation function; and
transferring map information from the subregion of the second digital map into the subregion of the first digital map depending on the reliability indicator.

11. The method of claim 1, wherein the map information comprises an object that is listed in the subregion of the second digital map but not in the subregion of the first digital map.

12. A device for merging map information from a first digital map and a second digital map, comprising:
a control unit configured to:
determine, for a subregion of the first and second digital map, a set of pairwise mappings between a first object from the first digital map and a second object from the second digital map;
determine a set of displacements that bring the set of mapped first and second objects into alignment with one another;
determine a deformation function for deforming a partial grid for the subregion of the first and second digital map depending on the set of displacements; and
transfer, using the deformation function, map information from the subregion of the second digital map into the subregion of the first digital map.
